(19) United States
(12) Patent Application Publication
(10) Pub. No.: US 2019/0081741 A1
(43) Pub. Date: Mar. 14, 2019

(54) Hybrid Automatic Repeat Request Feedback Design For Grant-Free Transmission In Mobile Communications

(71) Applicant: MediaTek Singapore Pte. Ltd., Singapore (SG)

(72) Inventors: Mohammed S. Aleabe Al-Imari, Cambridge (GB); Abdelkader Medles, Cambridge (GB)

(21) Appl. No.: 16/127,183

(22) Filed: Sep. 10, 2018

Related U.S. Application Data
(60) Provisional application No. 62/556,536, filed on Sep. 11, 2017.

(51) Int. Cl. H04L 1/18; H04L 1/16; H04W 72/04; H04L 5/00

(52) U.S. Cl. CPC H04L 1/1812; H04L 5/0055; H04W 72/042; H04L 1/1614

(57) ABSTRACT

Various solutions for hybrid automatic repeat request (HARQ) feedback design for grant-free transmission with respect to user equipment and network apparatus in mobile communications are described. An apparatus may perform a grant-free transmission to transmit at least one of repetitions to a network node. The apparatus may receive a feedback from the network node. The apparatus may terminate the grant-free transmission after receiving the feedback. A part of the repetitions may not be transmitted after terminating the grant-free transmission.

### CROSS REFERENCE TO RELATED PATENT APPLICATION(S)

The present disclosure is part of a non-provisional application claiming the priority benefit of U.S. Patent Application No. 62/556,536, filed on 11 Sep. 2017, the content of which is incorporated by reference in its entirety.

### TECHNICAL FIELD

The present disclosure is generally related to mobile communications and, more particularly, to hybrid automatic repeat request (HARQ) feedback design for grant-free transmission with respect to user equipment and network apparatus in mobile communications.

### BACKGROUND

Unless otherwise indicated herein, approaches described in this section are not prior art to the claims listed below and are not admitted as prior art by inclusion in this section.

In New Radio (NR), ultra-reliable and low latency communications (URLLC) is supported for emerging applications that demands high requirements on end-to-end latency and reliability. A general URLLC reliability requirement for one transmission of a packet is 1-10⁻⁵ for 32 bytes with a user plane latency of 1 ms. For URLLC, the target for user plane latency should be 0.5 ms for uplink and 0.5 ms for downlink.

The uplink grant-free transmission or the semi-persistent scheduling (SPS) transmission can be used to reduce the latency of URLLC services. The user equipment (UE) may be configured to transmit its uplink data on the configured grant without transmitting a prior request to improve the transmission latency. The network may pre-configure specific radio resources (e.g., time and frequency resources) for the UE to perform the SPS/grant-free transmissions.

In order to increase the reliability or the robustness for the URLLC transmissions, the UE may be configured to transmit repetitions for uplink information. For example, uplink grant-free transmissions may be configured with repetitions. Since the network node may allow several UEs to share the same resources on the grant-free basis, collisions between the grant-free uplink UEs may happen if the resources are not enough. In addition, if there is no feedback mechanism for the uplink grant-free transmission, the UE will finish all the repetition transmissions. Even if the network node has successfully decoded the uplink data from the first few repetitions, the UE may still need to transmit all the remaining repetitions. As such, the radio resources may be wasted due to the unnecessary transmissions.

Accordingly, a feedback scheme may need to be combined with the uplink grant-free transmission in order to save radio resources and reduce collisions. Therefore, it is needed to provide proper HARQ feedback design for the uplink grant-free transmission.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to HARQ feedback design for grant-free transmission with respect to user equipment and network apparatus in mobile communications.

In one aspect, a method may involve an apparatus performing a grant-free transmission to transmit at least one of repetitions to a network node. The method may also involve the apparatus receiving a feedback from the network node. The method may further involve the apparatus terminating the grant-free transmission after receiving the feedback. A part of the repetitions may not be transmitted after terminating the grant-free transmission.

In one aspect, an apparatus may comprise a transceiver capable of wirelessly communicating with a plurality of nodes of a wireless network. The apparatus may also comprise a processor communicatively coupled to the transceiver. The processor may be capable of performing a grant-free transmission to transmit at least one of repetitions to a network node. The processor may also be capable of receiving a feedback from the network node. The processor may further be capable of terminating the grant-free transmission after receiving the feedback. A part of the repetitions may not be transmitted after terminating the grant-free transmission.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario under schemes in accordance with implementations of the present disclosure.

FIG. 2 is a diagram depicting an example scenario under schemes in accordance with implementations of the present disclosure.

FIG. 3 is a diagram depicting an example scenario under schemes in accordance with implementations of the present disclosure.

FIG. 4 is a diagram depicting an example scenario under schemes in accordance with implementations of the present disclosure.

FIG. 5 is a diagram depicting an example scenario under schemes in accordance with implementations of the present disclosure.

FIG. 6 is a block diagram of an example communication apparatus and an example network apparatus in accordance with an implementation of the present disclosure.

FIG. 7 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to HARQ feedback design for grant-free transmission with respect to user equipment and network apparatus in mobile communications. According to the present disclosure, a number of possible solutions may be implemented separately or jointly. That is, although these possible solutions may be described below separately, two or more of these possible solutions may be implemented in one combination or another.

In NR, the network node may configure two types of uplink grants for the UE to perform uplink transmissions. The uplink grant may indicate some specific radio resources (e.g., time and frequency resources) for the UE to perform uplink transmission. One type of the uplink grant may comprise the dynamic grant. The dynamic grant may be configured based on the UE's request. For example, the UE may transmit a prior request (e.g., service request (SR), random-access channel (RACH) request or buffer status report (BSR)) to the network. After receiving the request, the network may configure the dynamic grant according to UE's request for the UE to perform uplink data transmission.

The other type of the uplink grant may comprise the configured grant. The configured grant may be configured by the network without UE's request. The uplink transmission based on the configured grant may be called the grant-free transmission or the SPS transmission. For example, the uplink grant-free transmission or the SPS transmission may be used to reduce the latency of URLLC services. The UE may be configured to transmit its uplink data on the configured grant without transmitting a prior request to improve the transmission latency. The network may pre-configure specific radio resources (e.g., time and frequency resources) for the UE to perform the SPS/grant-free transmissions.

In order to increase the reliability or the robustness for the URLLC transmissions, the UE may be configured to transmit at least one of repetitions for uplink information. For example, uplink grant-free transmissions may be configured with repetitions in NR. Since the network node may allow several UEs to share the same resources on the grant-free basis, collisions between grant-free uplink UEs may happen if the resources are not enough. For example, assuming that N_{sb} sub-bands are used, and K UEs can transmit at the same time, in a case that K>N_{sb}, the grant-free transmissions from certain UEs may collide due to limited resources.

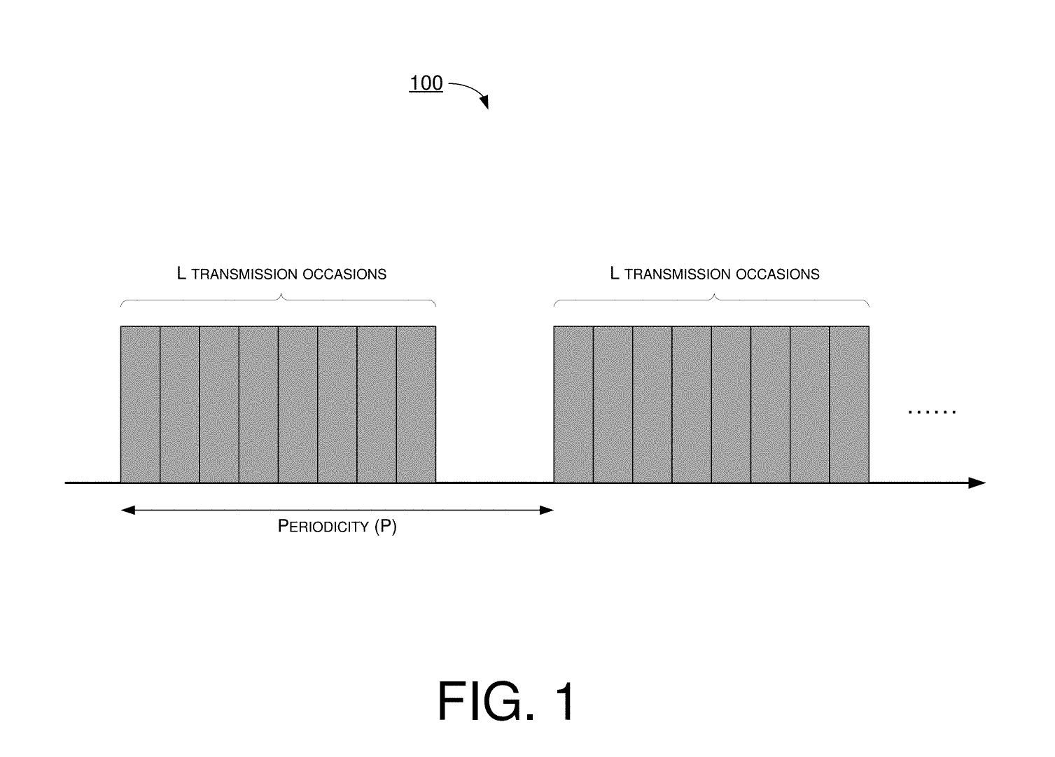

FIG. 1 illustrates an example scenario 100 under schemes in accordance with implementations of the present disclosure. Scenario 100 involves a UE and a network node, which may be a part of a wireless communication network (e.g., an LTE network, an LTE-Advanced network, an LTE-Advanced Pro network, a 5G network, an NR network, an IoT network or an NB-IoT network). The UE may be configured to transmit at least one of repetitions to increase the reliability or the robustness for the uplink transmissions. For example, the UE may be configured to transmit a plurality of repetitions in L transmission occasions. In a case that there is no feedback mechanism for the uplink grant-free transmission, the UE will finish the L repetitions unless there is a new uplink grant. Even if the network node has successfully decoded the uplink data from the first few repetitions, the UE may still need to transmit all the remaining repetitions. Accordingly, the radio resources may be wasted for the unnecessary transmissions. In a case that the grant-free transmission resources are shared by a plurality of UEs, collisions among the plurality of UEs may also happen due to the repetition transmissions.

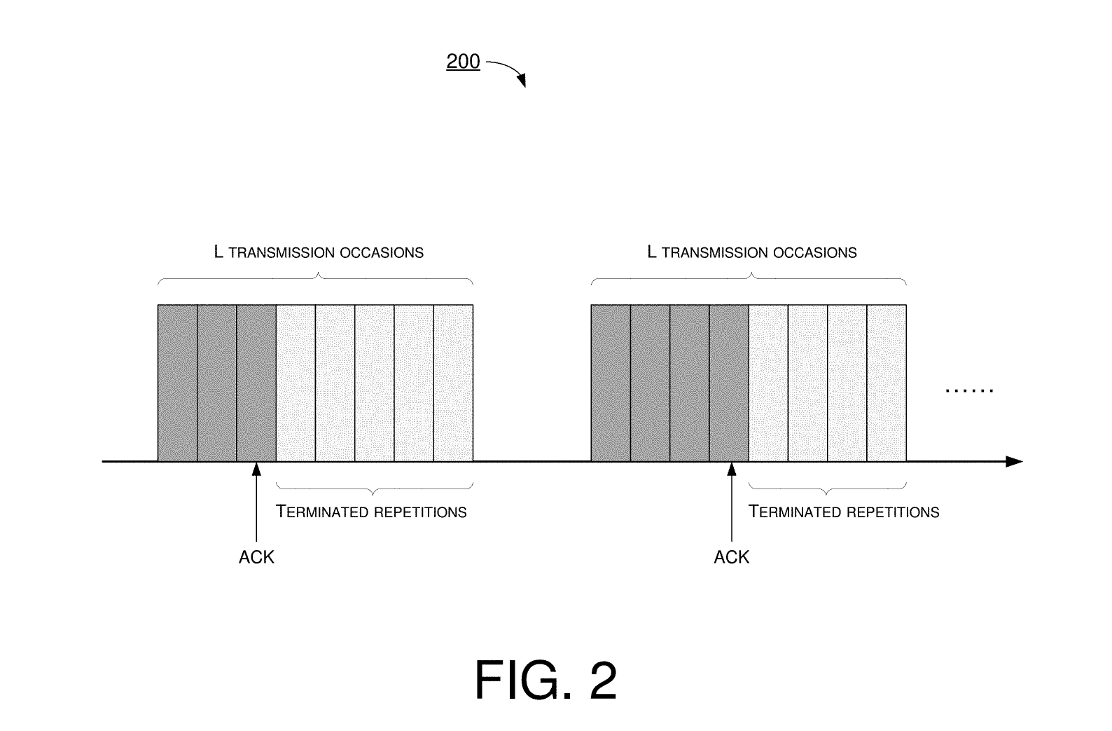

FIG. 2 illustrates an example scenario 200 under schemes in accordance with implementations of the present disclosure. Scenario 200 involves a UE and a network node, which may be a part of a wireless communication network (e.g., an LTE network, an LTE-Advanced network, an LTE-Advanced Pro network, a 5G network, an NR network, an IoT network or an NB-IoT network). The UE may be configured to perform the grant-free transmission to transmit at least one of repetitions in L transmission occasions to the network node. In a case that the network node is able to successfully decode the uplink data from the first few repetitions, the network node may be configured to transmit a feedback to the UE. The feedback may comprise, for example and without limitation, an acknowledgement (ACK). After receiving the feedback from the network node, the UE may be configured to terminate the grant-free transmission and skip the transmission for the remaining repetitions. Thus, a part of the repetitions may not be transmitted after terminating the grant-free transmission. For example, after transmitting 3 repetitions, the UE may receive an ACK from the network node. The UE may be configured to terminate the grant-free transmission and stop transmitting the remaining repetitions to the network node. Similarly, when initiating a new grant-free transmission, the UE may be able to terminate the grant-free transmission once receiving an ACK from the network node. Accordingly, the UE may not need to transmit all the repetitions in the L transmission occasions. The radio resources for the unnecessary repetition transmissions may be saved and the collisions among different UEs may also be reduced.

In order to properly send the feedback for the uplink transmission without grant (i.e., uplink grant-free transmission), the feedback schemes and the feedback signal format may need to be properly designed. Specifically, the feedback schemes may comprise a HARQ feedback mechanism. The network node may be configured to use the group-common downlink control information (DCI) to carry the HARQ feedback. The group-common DCI may be carried in the physical downlink control channel (PDCCH). The DCI size may be configured via radio resource control (RRC) signaling. The group-common DCI may comprise a plurality of feedback fields to support multiple users HARQ feedbacks. In addition, the feedback scheme may also need to support a plurality of HARQ processes for the same UE.

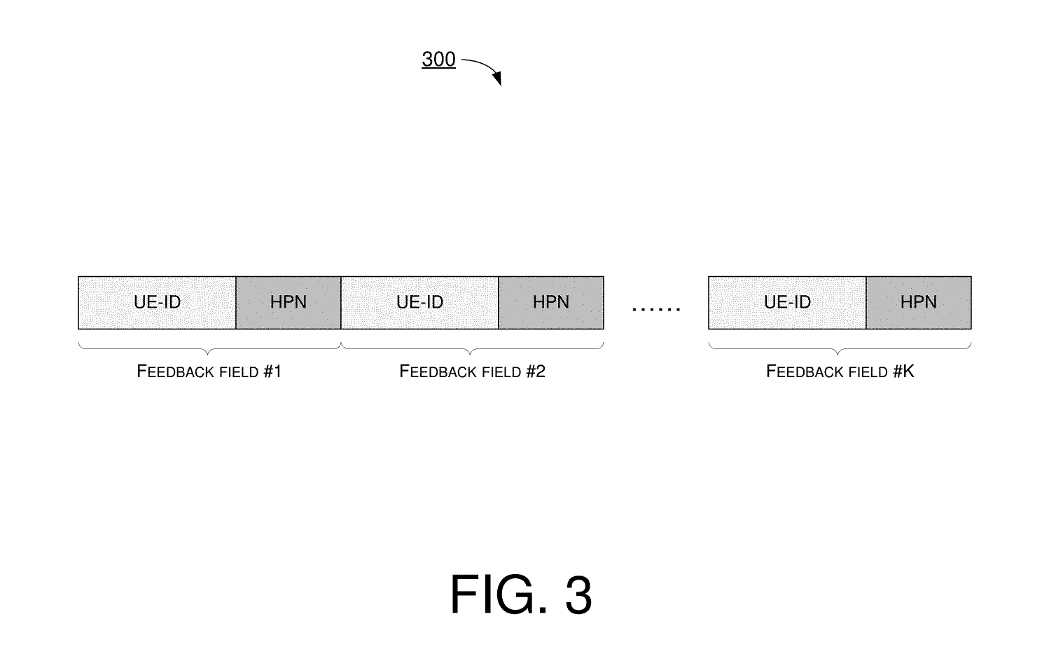

FIG. 3 illustrates an example scenario 300 under schemes in accordance with implementations of the present disclosure. Scenario 300 involves a plurality of UEs and a network node, which may be a part of a wireless communication network (e.g., an LTE network, an LTE-Advanced network, an LTE-Advanced Pro network, a 5G network, an NR network, an IoT network or an NB-IoT network). FIG. 3 illustrates the feedback signal format in the group-common DCI for enabling the HARQ feedback of the uplink transmission without grant. The network node may be configured to transmit the group-common DCI in a physical L1/L2 broadcast channel. The network node may be able to provide the HARQ feedback of the uplink transmission without grant for a group of UEs. Thus, a group of UEs may be associated with the group-common DCI. For example, N UEs may be supported by a group-common DCI.

As shown in FIG. 3, the group-common DCI may be divided into a plurality of feedback fields. Each feedback field may comprise a UE-identity (ID) part and the associated HARQ process number (HPN) for a specific UE. The UE-ID part may consist of log₂(N) bits that indicate which UE is addressed by the feedback filed. The UE may be configured to identify its feedback (e.g., feedback field) according to the UE-ID. The HPN field may consist of log₂(M) bits that indicate which HARQ process the feedback is associated. M may be the maximum number of the HARQ processes for a UE. Accordingly, each feedback field may consist of log₂(N)+log₂(M) bits. The group-common DCI may comprise K feedback fields for a plurality of UEs or a plurality of HARQ processes. For transmitting the feedback of K HARQ processes, K×(log₂(N)+log₂(M)) bits may be required in the group-common DCI.

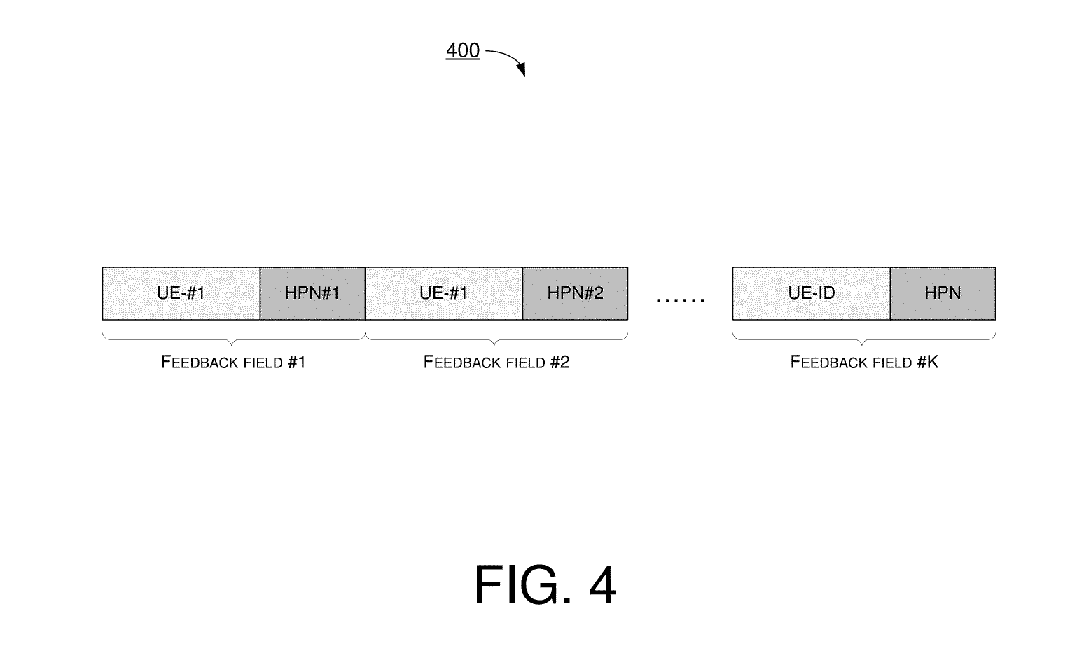

In a case that more than one HARQ is fed back to the same UE, multiple feedback fields may be used for the same UE. For example, FIG. 4 illustrates an example scenario 400 under schemes in accordance with implementations of the present disclosure. As shown in FIG. 4, feedback field #1 and feedback field #2 may associate with the same UE (e.g., UE-#1). HPN #1 and HPN #2 may associate with two HARQ processes of the same UE. The number of supported UEs in the group-common DCI (i.e., N) may be dynamically changed by higher layer configurations (e.g., RRC signaling). This may change the required number of bits for each feedback field.

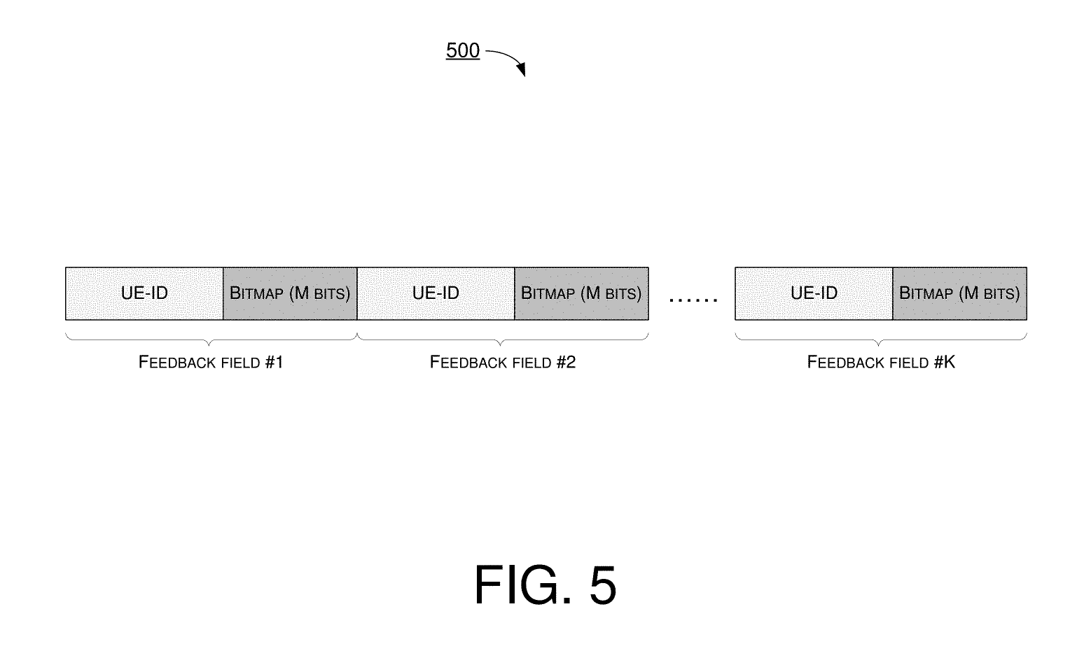

FIG. 5 illustrates an example scenario 500 under schemes in accordance with implementations of the present disclosure. Scenario 500 involves a plurality of UEs and a network node, which may be a part of a wireless communication network (e.g., an LTE network, an LTE-Advanced network, an LTE-Advanced Pro network, a 5G network, an NR network, an IoT network or an NB-IoT network). FIG. 5 illustrates an alternative design to use a bitmap to indicate a plurality of HARQ processes for each UE. Specifically, each feedback filed in the group-common DCI may comprise a UE-ID part and a bitmap. The UE-ID part may consist of log₂(N) bits that indicate which UE is addressed by the feedback filed. The UE may be configured to identify its feedback (e.g., feedback field) according to the UE-ID. The bitmap may be configured to indicate a plurality of HARQ processes associated with the UE-ID. For example, the bitmap may comprise M bits for indicating M HARQ processes. Each bit of the bitmap may correspond to a HARQ process of the UE. All or a plurality of HARQ processes of one UE may be addressed within one feedback field. Each feedback field may consist of log₂(N)+M bits. The UE-ID used in the feedback field may be determined based on the radio network temporary identifier (RNTI). For example, the UE-ID may be determined according to a prat of the RNTI bits. The UE-ID or the RNTI may be configured by higher layers (e.g., RRC layer).

Alternatively, the feedback field in the group-common DCI may comprise an N-bit bitmap for a plurality of UEs or a plurality of HARQ processes. Each bit of the bitmap may correspond to a HARQ process of a UE. For example, the bitmap may be associated with N UEs and each UE may comprise M HARQ processes. Thus, the feedback field may consist of N×M bits in total. In a case that the number of HARQ processes is different for each UE, the bitmap length may correspond to the sum of all the HARQ processes through all the UEs. Since the network node may know which UEs are configured with the grant-free transmission, the network node may arrange the bit positions for indicating feedback to different UEs. The UE may be configured to identify its feedback according to the bit position. The bit position needed to be monitored for each UE may be signaled to the UEs or may be inferred according to the RNTI or the UE-ID.

### Illustrative Implementations

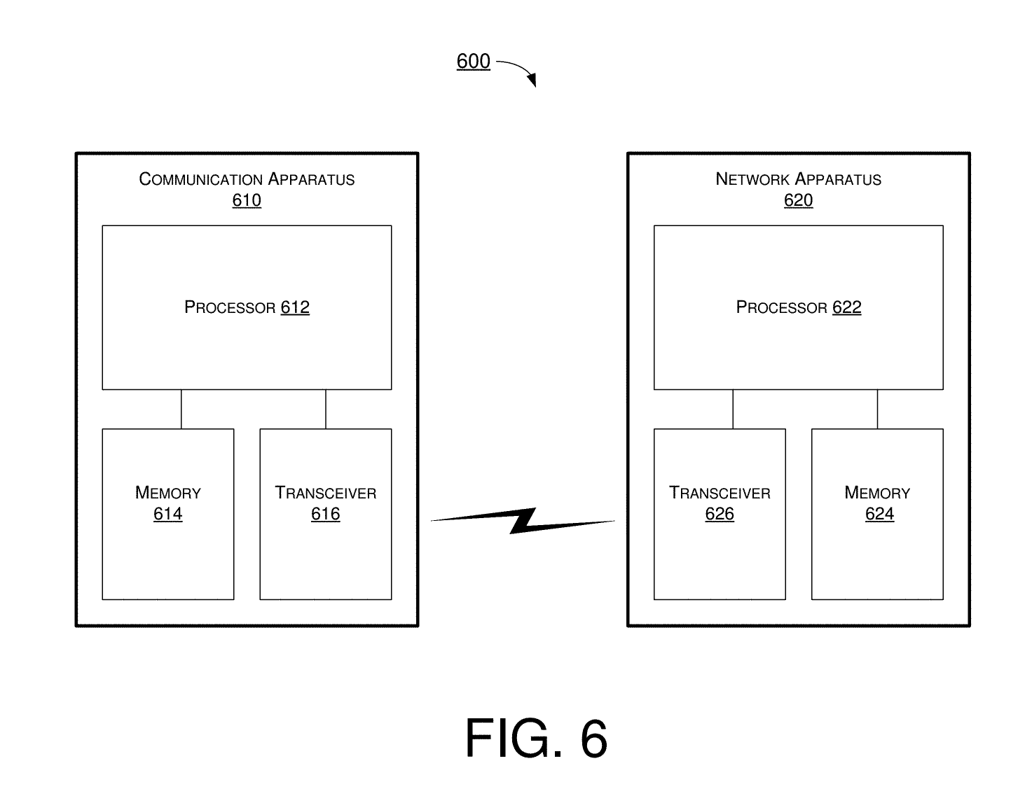

FIG. 6 illustrates an example communication apparatus 610 and an example network apparatus 620 in accordance with an implementation of the present disclosure. Each of communication apparatus 610 and network apparatus 620 may perform various functions to implement schemes, techniques, processes and methods described herein pertaining to HARQ feedback design for grant-free transmission with respect to user equipment and network apparatus in wireless communications, including scenarios 100, 200, 300, 400 and 500 described above as well as process 700 described below.

Communication apparatus 610 may be a part of an electronic apparatus, which may be a UE such as a portable or mobile apparatus, a wearable apparatus, a wireless communication apparatus or a computing apparatus. For instance, communication apparatus 610 may be implemented in a smartphone, a smartwatch, a personal digital assistant, a digital camera, or a computing equipment such as a tablet computer, a laptop computer or a notebook computer. Communication apparatus 610 may also be a part of a machine type apparatus, which may be an IoT or NB-IoT apparatus such as an immobile or a stationary apparatus, a home apparatus, a wire communication apparatus or a computing apparatus. For instance, communication apparatus 610 may be implemented in a smart thermostat, a smart fridge, a smart door lock, a wireless speaker or a home control center. Alternatively, communication apparatus 610 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 610 may include at least some of those components shown in FIG. 6 such as a processor 612, for example. communication apparatus 610 may further include one or more other components not pertinent to the proposed scheme of the present disclosure (e.g., internal power supply, display device and/or user interface device), and, thus, such component(s) of communication apparatus 610 are neither shown in FIG. 6 nor described below in the interest of simplicity and brevity.

Network apparatus 620 may be a part of an electronic apparatus, which may be a network node such as a base station, a small cell, a router or a gateway. For instance, network apparatus 620 may be implemented in an eNodeB in an LTE, LTE-Advanced or LTE-Advanced Pro network or in a gNB in a 5G, NR, IoT or NB-IoT network. Alternatively, network apparatus 620 may be implemented in the form of one or more IC chips such as, for example and without limitation, one or more single-core processors, one or more multi-core processors, or one or more RISC or CISC processors. Network apparatus 620 may include at least some of those components shown in FIG. 6 such as a processor 622, for example. Network apparatus 620 may further include one or more other components not pertinent to the proposed scheme of the present disclosure (e.g., internal power supply, display device and/or user interface device), and, thus, such component(s) of network apparatus 620 are neither shown in FIG. 6 nor described below in the interest of simplicity and brevity.

In one aspect, each of processor 612 and processor 622 may be implemented in the form of one or more single-core processors, one or more multi-core processors, or one or more CISC processors. That is, even though a singular term “a processor” is used herein to refer to processor 612 and processor 622, each of processor 612 and processor 622 may include multiple processors in some implementations and a single processor in other implementations in accordance with the present disclosure. In another aspect, each of processor 612 and processor 622 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 612 and processor 622 is a special-purpose machine specifically designed, arranged and configured to perform specific tasks including power consumption reduction in a device (e.g., as represented by communication apparatus 610) and a network (e.g., as represented by network apparatus 620) in accordance with various implementations of the present disclosure.

In some implementations, communication apparatus 610 may also include a transceiver 616 coupled to processor 612 and capable of wirelessly transmitting and receiving data. In some implementations, communication apparatus 610 may further include a memory 614 coupled to processor 612 and capable of being accessed by processor 612 and storing data therein. In some implementations, network apparatus 620 may also include a transceiver 626 coupled to processor 622 and capable of wirelessly transmitting and receiving data. In some implementations, network apparatus 620 may further include a memory 624 coupled to processor 622 and capable of being accessed by processor 622 and storing data therein. Accordingly, communication apparatus 610 and network apparatus 620 may wirelessly communicate with each other via transceiver 616 and transceiver 626, respectively. To aid better understanding, the following description of the operations, functionalities and capabilities of each of communication apparatus 610 and network apparatus 620 is provided in the context of a mobile communication environment in which communication apparatus 610 is implemented in or as a communication apparatus or a UE and network apparatus 620 is implemented in or as a network node of a communication network.

In some implementations, processor 612 may be configured to perform, via transceiver 616, the grant-free transmission to transmit at least one of repetitions in L transmission occasions to network apparatus 620. In a case that processor 622 is able to successfully decode the uplink data from the first few repetitions, processor 622 may be configured to transmit, via transceiver 626, a feedback to communication apparatus 610. Processor 622 may transmit, for example and without limitation, an acknowledgement (ACK) to communication apparatus 610. After receiving the feedback from the network node, processor 612 may be configured to terminate the grant-free transmission and skip the transmission for the remaining repetitions. Thus, a part of the repetitions may not be transmitted after terminating the grant-free transmission. For example, after transmitting 3 repetitions, processor 612 may receive, via transceiver 616, an ACK from communication apparatus 610. Processor 612 may be configured to terminate the grant-free transmission and stop transmitting the remaining repetitions to communication apparatus 610. Similarly, when initiating a new grant-free transmission, processor 612 may be able to terminate the grant-free transmission once receiving an ACK from communication apparatus 610. Accordingly, processor 612 may not need to transmit all the repetitions in the L transmission occasions.

In some implementations, processor 622 may be configured to use the group-common DCI to carry the HARQ feedback. Processor 622 may transmit the group-common DCI in the PDCCH. Processor 622 may configure the DCI size by RRC signaling. Processor 622 may use a plurality of feedback fields in the group-common DCI to support multiple users HARQ feedbacks. Processor 622 may transmit the HARQ feedbacks to a plurality of different UEs. In addition, processor 622 may also be able to transmit feedbacks associated with a plurality of HARQ processes for the same UE.

In some implementations, processor 622 may be configured to transmit the group-common DCI in a physical L1/L2 broadcast channel. Processor 622 may be able to provide the HARQ feedback of the uplink transmission without grant for a group of UEs. Thus, a group of UEs may be associated with the group-common DCI. For example, N UEs may be supported by a group-common DCI.

In some implementations, processor 622 may divide the group-common DCI into a plurality of feedback fields. Each feedback field may comprise a UE-ID part and the associated HPN for a specific UE. Processor 622 may use the UE-ID part which consist of log₂(N) bits to indicate which UE is addressed by the feedback filed. Processor 612 may be configured to identify its feedback (e.g., feedback field) according to the UE-ID. Processor 622 may use the HPN field which consist of log₂(M) bits to indicate which HARQ process the feedback is associated. M may be the maximum number of the HARQ processes for a UE. Accordingly, processor 622 may use log₂(N)+log₂(M) bits for each feedback field. Processor 622 may use K feedback fields in the group-common DCI for a plurality of UEs or a plurality of HARQ processes. For transmitting the feedback of K HARQ processes, processor 622 may use K×(log₂(N)+log₂(M)) bits in the group-common DCI.

In some implementations, in a case that more than one HARQ needed to be fed back to the same UE, processor 622 may use multiple feedback fields for the same UE. For example, feedback field #1 and feedback field #2 may associate with the same UE (e.g., UE-#1). HPN #1 and HPN #2 may associate with two HARQ processes of the same UE. Processor 622 may dynamically change the number of supported UEs in the group-common DCI (i.e., N) by higher layer configurations (e.g., RRC signaling). This may change the required number of bits for each feedback field.

In some implementations, processor 622 may be configured to use a bitmap to indicate a plurality of HARQ processes for each UE. Each feedback filed in the group-common DCI may comprise a UE-ID part and a bitmap. Processor 622 may use the UE-ID part which consist of log₂(N) bits to indicate which UE is addressed by the feedback filed. Processor 612 may be configured to identify its feedback (e.g., feedback field) according to the UE-ID. Processor 622 may use the bitmap to indicate a plurality of HARQ processes associated with the UE-ID. For example, processor 622 may use M bits in the bitmap to indicate M HARQ processes. Each bit of the bitmap may correspond to a HARQ process of the UE. Processor 622 may use one feedback field to address all or a plurality of HARQ processes of one UE. Processor 622 may use log₂(N)+M bits in each feedback field. Processor 622 may determine the UE-ID used in the feedback field based on the RNTI. For example, processor 622 may determine the UE-ID according to a prat of the RNTI bits. Processor 622 may configure the UE-ID or the RNTI by higher layers (e.g., RRC layer).

In some implementations, processor 622 may use an N-bit bitmap in the group-common DCI for a plurality of UEs or a plurality of HARQ processes. Processor 622 may use one bit of the bitmap to indicate the feedback of a HARQ process of a UE. For example, the bitmap may be associated with N UEs and each UE may comprise M HARQ processes. Thus, processor 622 may use N×M bits in total in the feedback field. In a case that the number of HARQ processes is different for each UE, the bitmap length may correspond to the sum of all the HARQ processes through all the UEs. Since processor 622 may know which UEs are configured with the grant-free transmission, processor 622 may arrange the bit positions for indicating feedback to different UEs. Processor 612 may be configured to identify its feedback according to the bit position. Processor 622 may signal the bit position needed to be monitored for each UE to the UEs. Processor 612 may also infer the bit position needed to be monitored according to the RNTI or the UE-ID.

### Illustrative Processes

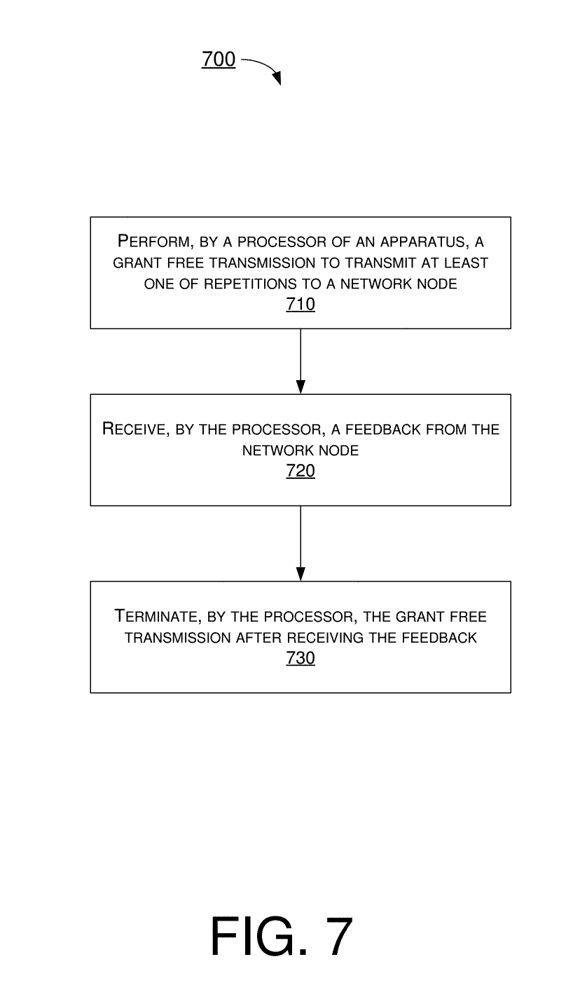

FIG. 7 illustrates an example process 700 in accordance with an implementation of the present disclosure. Process 700 may be an example implementation of scenarios 100, 200, 300, 400 and 500, whether partially or completely, with respect to HARQ feedback design for grant-free transmission in accordance with the present disclosure. Process 700 may represent an aspect of implementation of features of communication apparatus 610. Process 700 may include one or more operations, actions, or functions as illustrated by one or more of blocks 710, 720 and 730. Although illustrated as discrete blocks, various blocks of process 700 may be divided into additional blocks, combined into fewer blocks, or eliminated, depending on the desired implementation. Moreover, the blocks of process 700 may executed in the order shown in FIG. 7 or, alternatively, in a different order. Process 700 may be implemented by communication apparatus 610 or any suitable UE or machine type devices. Solely for illustrative purposes and without limitation, process 700 is described below in the context of communication apparatus 610. Process 700 may begin at block 710.

At 710, process 700 may involve processor 612 of apparatus 610 performing a grant-free transmission to transmit at least one of repetitions to a network node. Process 700 may proceed from 710 to 720.

At 720, process 700 may involve processor 612 receiving a feedback from the network node. Process 700 may proceed from 720 to 730.

At 730, process 700 may involve processor 612 terminating the grant-free transmission after receiving the feedback. Accordingly, a part of the repetitions may not be transmitted after terminating the grant-free transmission.

In some implementations, the feedback may comprise an ACK and/or a UE ID.

In some implementations, process 700 may involve processor 612 identifying the feedback according to the UE ID.

In some implementations, the feedback may comprise an HPN.

In some implementations, the feedback may comprise a bitmap to indicate a plurality of HARQ processes.

In some implementations, the feedback may comprise a bitmap corresponding to a plurality of UEs.

In some implementations, each bit of the bitmap may correspond to a HARQ process of a UE.

In some implementations, process 700 may involve processor 612 identifying the feedback according to a bit position.

In some implementations, the feedback may be carried in the group-common DCI.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
performing, by a processor of an apparatus, a grant-free transmission to transmit at least one of repetitions to a network node;
receiving, by the processor, a feedback from the network node; and
terminating, by the processor, the grant-free transmission after receiving the feedback,
wherein a part of the repetitions are not transmitted after terminating the grant-free transmission.

2. The method of claim 1, wherein the feedback comprises an acknowledgement (ACK).

3. The method of claim 1, wherein the feedback comprises a user equipment (UE) identity (ID).

4. The method of claim 3, further comprising:
identifying, by the processor, the feedback according to the UE ID.

5. The method of claim 1, wherein the feedback comprises a hybrid automatic repeat request (HARQ) process number (HPN).

6. The method of claim 1, wherein the feedback comprises a bitmap to indicate a plurality of hybrid automatic repeat request (HARQ) processes.

7. The method of claim 1, wherein the feedback comprises a bitmap corresponding to a plurality of user equipment (UE).

8. The method of claim 7, wherein each bit of the bitmap corresponds to a hybrid automatic repeat request (HARQ) process of a UE.

9. The method of claim 7, further comprising:
identifying, by the processor, the feedback according to a bit position.

10. The method of claim 1, wherein the feedback is carried in group-common downlink control information (DCI).

11. An apparatus, comprising:
a transceiver capable of wirelessly communicating with a plurality of nodes of a wireless network; and
a processor communicatively coupled to the transceiver, the processor capable of:
performing, via the transceiver, a grant-free transmission to transmit at least one of repetitions to a network node;
receiving, via the transceiver, a feedback from the network node; and
terminating the grant-free transmission after receiving the feedback,
wherein a part of the repetitions are not transmitted after terminating the grant-free transmission.

12. The apparatus of claim 11, wherein the feedback comprises an acknowledgement (ACK).

13. The apparatus of claim 11, wherein the feedback comprises a user equipment (UE) identity (ID).

14. The apparatus of claim 13, wherein the processor is further capable of:
identifying the feedback according to the UE ID.

15. The apparatus of claim 11, wherein the feedback comprises a hybrid automatic repeat request (HARQ) process number (HPN).

16. The apparatus of claim 11, wherein the feedback comprises a bitmap to indicate a plurality of hybrid automatic repeat request (HARQ) processes.

17. The apparatus of claim 11, wherein the feedback comprises a bitmap corresponding to a plurality of user equipment (UE).

18. The apparatus of claim 17, wherein each bit of the bitmap corresponds to a hybrid automatic repeat request (HARQ) process of a UE.

19. The apparatus of claim 17, wherein the processor is further capable of:
identifying the feedback according to a bit position.

20. The apparatus of claim 11, wherein the feedback is carried in group-common downlink control information (DCI).
